(19) United States
(12) Patent Application Publication
(10) Pub. No.: US 2003/0047327 A1
(43) Pub. Date: Mar. 13, 2003

(54) Fire suppression apparatus with variable aeration mixing rate nozzle

(76) Inventor: Daniel A. Gilbert, Boise, ID (US)

Correspondence Address: Joseph W. Holland, P.O. Box 1840, Boise, ID, 83701-1840, US

(21) Appl. No.: 09/952,903

(22) Filed: Sep. 13, 2001

(51) Int. Cl. A62C 2/00

(52) U.S. Cl. 169/46; 169/13; 169/14; 239/318

(57) ABSTRACT

A fire suppression apparatus including a variable aeration mixing rate nozzle and a method for generating a foam discharge at a variable aeration mixing rate nozzle. The fire suppression apparatus includes a motor driven pump for pressurizing a fluid flow and a variable aeration mixing nozzle. A mixing chamber is connected to a pump intake. A surfactant reservoir is connected to the mixing chamber via a siphon line. A variable aeration mixing rate nozzle includes a nozzle section including a venturi for increasing flow velocity. An adjustable stream flow disrupter is located within the nozzle section for increasing flow turbulence. The flow disrupter is adjustable so as to provide a variable aeration mixing rate. The amount of turbulence induced by the flow disrupter may be varied by advancing or withdrawing the flow disrupter into or out of the pressurized fluid flow. The nozzle also includes an air intake for inducing ambient air to the pressurized flow.

### BACKGROUND OF THE INVENTION

1. Field of Invention

The present invention relates generally to devices for

producing a foam discharge for fighting fires and more particularly to a fire fighting apparatus including an improved nozzle having a variable aeration mixing rate capability.

2. Background of Invention

The prior art recognizes the utility of applying foam to a fire or flammable materials during a fire suppression effort for wetting and extinguishing the fire. The addition of a surfactant, for instance, a detergent, to a pressurized turbulent aerated stream of water creates a foam discharge which provides wetting that is superior to water. The use of foam may also extend a water supply at a fire site. In accordance with such known methods, the foam is generated in turbulence in the pressurized stream of water as it travels along a conduit. One disadvantage noted in systems that produce foam in this manner is that as a general rule, the more efficient a nozzle is at producing foam, the less efficient the nozzle becomes at projecting the pressurized stream to a greater distance. This may be of particular concern in instances where positioning the nozzle relative to the fire is limited or restricted and the fire suppression effort requires that the pressurized stream be projected to a still greater distance. In these situations there may be advantage to providing a nozzle having a variable rate foaming agent mixing capability so as to permit an operator to vary mixture of the air with the pressurized stream of water and thereby the distance that the pressurized stream of water is projected.

Additionally, while municipalities may provide emergency water delivery systems including hydrants as a source of fighting fires, when a large fire breaks out, as is commonly seen in the summer months in areas that border grasslands and forests, emergency water delivery systems may loose pressure and become overtaxed and of limited service. In addition, many rural areas provide no means or source of water for fire suppression. In these situations there may be advantage to providing a fire suppression apparatus including foam application capability that does not rely on a municipal source of water during a fire and which will provide the increased benefit of foam application in fire suppression efforts where limited water is available. In these situations there may also be advantage to providing a portable fire suppression apparatus that does not rely on a municipal source of water during a fire.

### SUMMARY OF THE INVENTION

The present invention is directed to a device, system and method for fire suppression employing a variable aeration mixing rate nozzle. The fire suppression apparatus of the present invention includes a variable aeration mixing rate nozzle for generating a foam discharge having a variable stream distance capability. In a first preferred embodiment of the invention, the fire suppression apparatus is configured as a fire suppression device including a motor driven pump and a variable aeration mixing nozzle. The pump includes a pump intake connected to an intake line, a first end of which is submersed in a water source, for instance a pond, pool, reservoir or other source of standing water or a creek, stream, river or other source of water. It is expected that the invention may be practiced as well in marine applications pumping either fresh or saline water. A second end of the intake line is connected to the pump intake allowing water to be drawn from the source and pressurized through a pump outlet. A mixing chamber is attached to the pump preferably at the intake. A line extends from the mixing chamber to a surfactant reservoir and provides a conduit through which the surfactant may be drawn and introduced into the pressurized stream. The pressurized stream is directed through a discharge line. Mixing of the surfactant with the pressurized stream is achieved along the length of the discharge line. However, in order to achieve improved foaming and variable rate foaming agent mixing capability a variable aeration mixing rate nozzle is attached at the output end of the discharge line.

According to the present invention, a variable aeration mixing rate nozzle includes a generally cylindrical nozzle section. The cylindrical nozzle section includes an aperture which projects through the cylindrical nozzle section along a longitudinal axis. A venturi is located within the cylindrical nozzle section for increasing flow velocity. An adjustable stream flow disrupter is also located within the cylindrical nozzle section for increasing flow turbulence and therefore the efficiency of foam generation. The cylindrical nozzle section also includes one or more air intake apertures formed through the wall of the cylindrical nozzle section downstream of the venturi for introducing ambient air to the pressurized flow.

In the preferred embodiment of the invention, the flow disrupter is adjustable so as to provide a variable aeration mixing rate. The flow disrupter is adjustable in the sense that the amount of turbulence induced by the flow disrupter may be varied. In one embodiment of the invention, the flow disrupter is configured as a screw that projects radially through the cylindrical nozzle section wall into the pressurized flow. The farther the screw is advanced through the cylindrical nozzle section wall into the pressurized flow, the greater the turbulence, the greater the rate of foam generation and the shorter the projection of the pressurized stream from the nozzle. Conversely, the further the screw is backed out through the cylindrical nozzle section wall, withdrawing the screw from the pressurized flow, the lower the turbulence, the lower the rate of foam generation and the longer the projection of the pressurized stream from the nozzle.

In an alternate embodiment the variable aeration mixing rate nozzle includes a cylindrical nozzle section having a first nozzle segment having a nipple which is insertable within a second nozzle segment. The flow disrupter is configured as one or more fingers that project at an angle from an interior wall of the cylindrical nozzle section, into the pressurized stream flow. The angle at which any given finger extends into the stream flow may be increased or decreased by a graduated insertion or withdrawal of a nipple against the one or more fingers. The first nozzle segment is preferably connected to the second nozzle segment by threaded engagement so that as the first nozzle segment advances against a second nozzle segment, the nipple is advance or retracted with respect to any given finger. The greater the angle between any given finger and an interior wall of the cylindrical nozzle section, the farther the finger projects into the pressurized flow, the greater the turbulence, the greater the rate of foam generation and the shorter the projection of the pressurized stream from the nozzle. Conversely, the less the angle between any given finger and the interior wall of the cylindrical nozzle section, the less the finger extends into the pressurized flow, the lower the turbulence, the lower the rate of foam generation and the longer the projection of the pressurized stream from the nozzle.

In the preferred embodiment of the invention, the flow disrupter is located upstream of the venturi, although the invention may be practiced by positioning the flow disrupter downstream of the venturi. Without limiting the invention, it is believed that locating the flow disrupter upstream of the venturi causes an increase in turbulence which is maintained following passage of the stream flow through the venturi. The increased turbulence before the venturi improves mixing of the foaming agent with the pressurized flow. Turbulence maintained following the venturi results in an improved mixing of ambient air introduced at the air intake apertures with the water/foaming agent mixture resulting in a higher rate of conversion of the water/foaming agent mixture to foam.

One preferred embodiment of the invention is configured as a portable fire suppression apparatus including a motor driven pump and a variable aeration mixing rate nozzle. The variable aeration mixing rate nozzle may be formed of a variety of materials and may be cast, machined, molded or formed by other known manufacturing processes.

A method for generating a foam discharge at a variable aeration mixing rate nozzle includes the steps of pressurizing a fluid flow, mixing a surfactant with a pressurized fluid flow, variably inducing a turbulent flow upstream of a

venturi, increasing flow velocity through the venturi, inducting ambient air into the pressurized fluid flow having an increased flow velocity and mixing the ambient air with the pressurized fluid flow having an increased flow velocity generating a foam discharge.

### BRIEF DESCRIPTION OF THE DRAWINGS

FIG. 1 is a representative schematic diagram of a portable fire suppression apparatus including a variable aeration mixing rate nozzle in accordance with the present invention;

FIG. 2 is a representative exploded perspective view of a variable aeration mixing rate nozzle in accordance with the present invention;

FIG. 3 is a representative side view of a variable aeration mixing rate nozzle in accordance with the present invention;

FIG. 4 is a representative exploded side view of a variable aeration mixing rate nozzle in accordance with the present invention;

FIG. 5 is a representative side view of a variable aeration mixing rate nozzle in accordance with the present invention;

FIG. 6 is a representative side view of a variable aeration mixing rate nozzle in accordance with the present invention; and

FIG. 7 is a schematic flow chart diagram of a method for generating a foam discharge at a variable aeration mixing rate nozzle.

### DETAILED DESCRIPTION

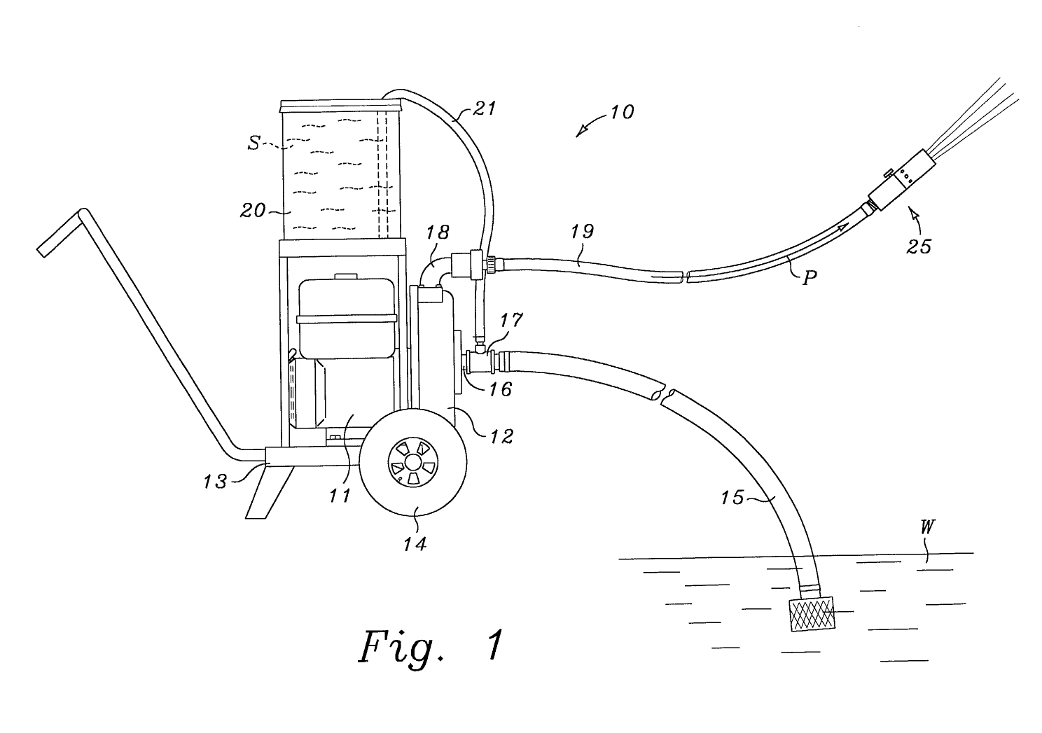

Referring to FIG. 1, fire suppression apparatus 10 is illustrated schematically. In this case, fire suppression apparatus 10 includes gas engine 11 which is coupled to and powers pump 12. Gas engine 11 and pump 12 are mounted in this case in frame 13 having a wheel 14 which facilitates manual transport of fire suppression apparatus 10. Intake line 15 is connected to and fluidly communicates with pump intake 16. Mixing chamber 17 is connected to and fluidly communicates with pump intake 16. Surfactant reservoir 20 is connected between and fluidly communicates with mixing chamber 17 via siphon line 21. Surfactant S is contained within surfactant reservoir 20 and may be drawn and introduced into mixing chamber 17 via siphon line 21.

As shown in FIG. 1, a first end of intake line 15 is submersed at water source W. A second end of intake line 15 is connected at pump 12. Water is drawn from water source W and pressurized by pump 12. Pressurized flow P is directed through discharge line 19 and out nozzle 25. Some mixing of surfactant S occurs within pressurized flow P along the length of discharge line 19. However, in order to achieve improved foaming, variable aeration mixing rate nozzle 25 is attached at the output end of discharge line 19.

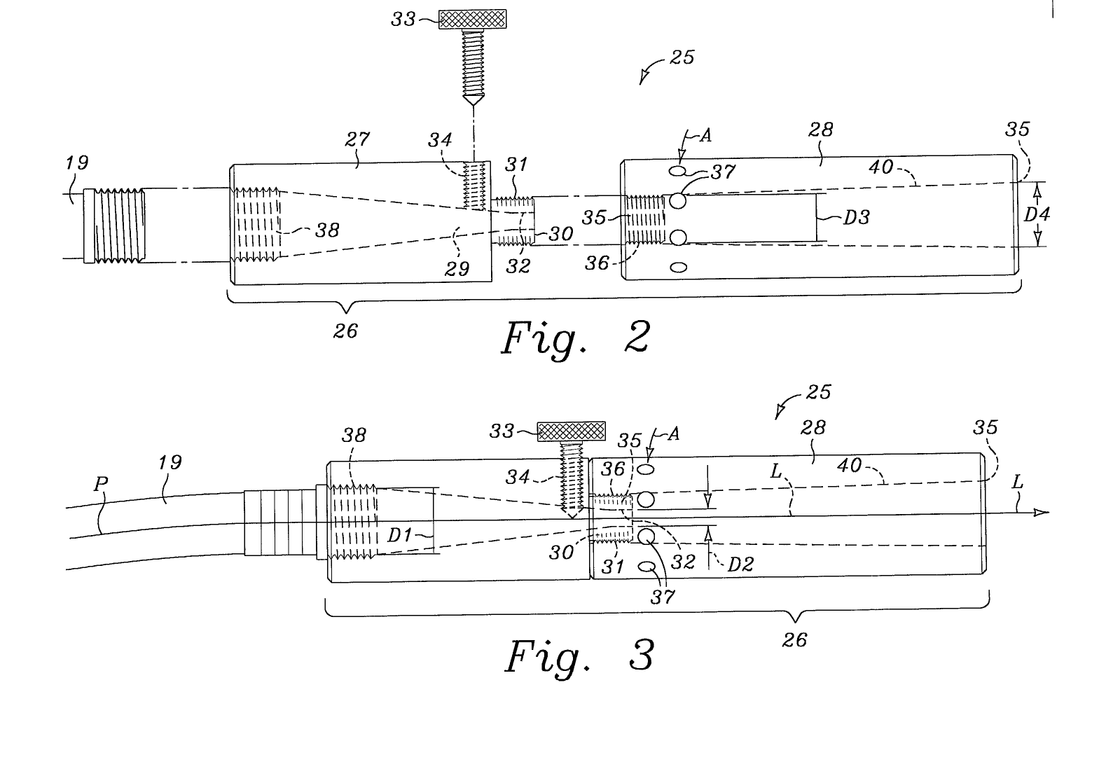

FIGS. 2 and 3 show a first preferred embodiment of variable aeration mixing rate nozzle 25. Variable aeration mixing rate nozzle 25 includes generally cylindrical nozzle section 26 including aperture 29 which projects through cylindrical nozzle section 26 along longitudinal axis L. Cylindrical nozzle section 26 is formed, in this instance, by threadedly connected first nozzle segment 27 and second nozzle segment 28.

First nozzle segment 27 includes venturi 32 for increasing flow velocity of pressurized flow P. First nozzle segment 27 also includes means for connecting the first nozzle segment 27 to discharge line 19. In the embodiment shown, first nozzle segment 27 of cylindrical nozzle section 26 includes threaded end 38 for threaded connection to discharge line 19. First nozzle segment 27 of cylindrical nozzle section 26 also includes coupler 30 having coupler external thread 31.

Second nozzle segment 28 includes air intake apertures 37 formed radiallay to longitudinal axis L through second nozzle segment 28 down stream of venturi 32. Ambient air A is introduced through air intake apertures 37 to pressurized flow P. Flare 40 is formed at discharge end 35 of second nozzle segment 28. Second nozzle segment 28 also includes coupler receiver 35 having coupler internal thread 36 for threaded connection with coupler external thread 31 of first nozzle segment 27.

In the embodiment of the invention shown in FIGS. 2 and 3 screw 33 serves the function of an adjustable stream flow disrupter. Screw 33 engages threaded aperture 34 and extends through first nozzle segment 27. Screw 33 is adjustable providing a variable aeration mixing rate. Screw 33 is adjustable in the sense that the amount of turbulence induced by screw 33 may be varied by advancing screw 33 through threaded aperture 34 into pressurized flow P. The further screw 33 is advanced into pressurized flow P, the greater the turbulence, the greater the rate of foam generation and the shorter projection of pressurized flow P from variable aeration mixing rate nozzle 25. Conversely, the further screw 33 is withdrawn from pressurized flow P, the lower the turbulence, the lower the rate of foam generation and the longer projection of pressurized flow P from variable aeration mixing rate nozzle 25.

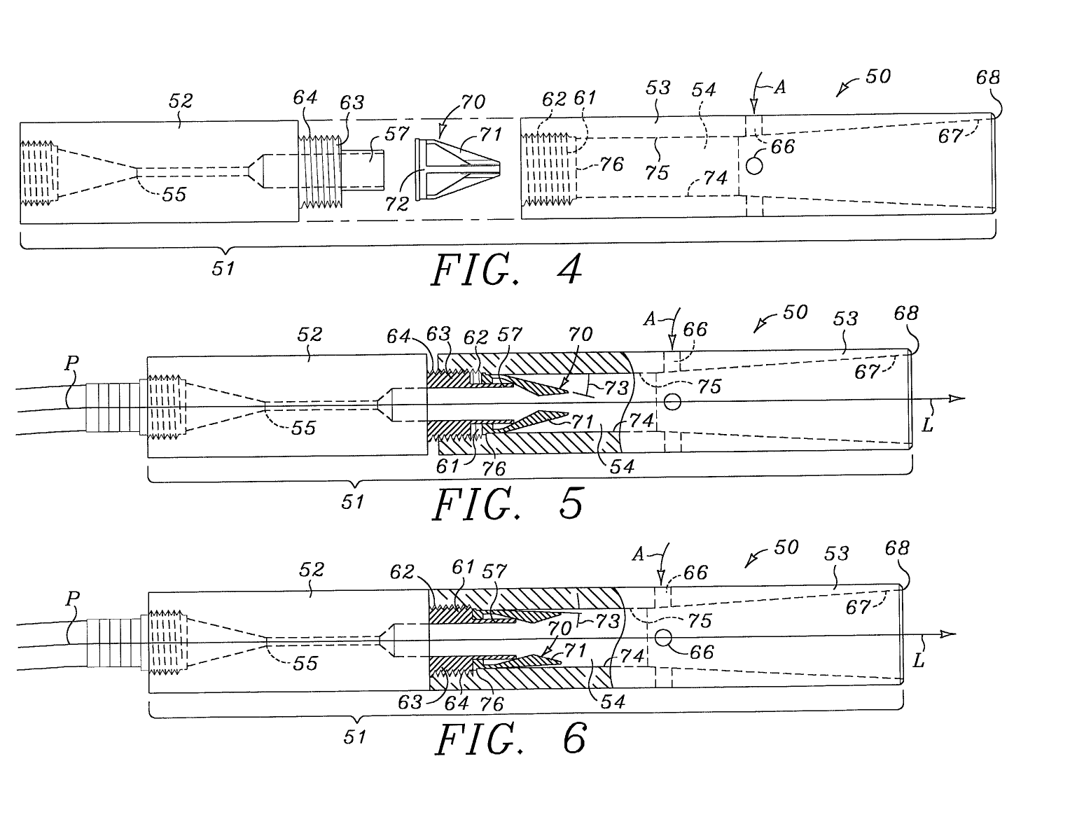

FIGS. 4 through 6 show an alternate preferred embodiment of variable aeration mixing rate nozzle 50 including cylindrical nozzle section 51 including first nozzle segment 52 and second nozzle segment 53. Aperture 54 projects through cylindrical nozzle section 51 along longitudinal axis L. Cylindrical nozzle section 51 is formed, in this instance, by threadedly connected first nozzle segment 52 and second nozzle segment 53. First nozzle segment 52 includes coupler 63 having coupler external thread 64. Venturi 55 is formed in the interior of first nozzle segment 52. Nipple 57 is formed contiguous to, concentric with and extends from a distal end of coupler 63.

Second nozzle segment 53 includes coupler receiver 61 including coupler internal thread 62 formed at a first end of second nozzle segment 53. Second nozzle segment 53 is defined by second nozzle segment wall 74 having interior surface 75. Interior surface 75 includes shoulder 76. Second nozzle segment 60 includes a plurality of air intake apertures 66 formed radiallay to longitudinal axis L. Ambient air A is introduced through air intake apertures 66 to pressurized flow P. Flare 67 is formed at discharge end 68 of second nozzle segment 53.

In the embodiment of the invention shown in FIGS. 5 through 7 finger assembly 70 serves the function of an adjustable stream flow disrupter. Finger assembly 70 includes a plurality of fingers 71 attached to finger retainer 72, with each of the fingers 71 extending at an adjustable finger angle 73 from finger retainer 72. Each of the fingers 71 are biased towards a closed position as shown in FIG. 4. As shown in FIGS. 5 and 6, each of the fingers 71, particularly each of the finger angles 73, are adjustable providing a variable aeration mixing rate. In this embodiment of the invention, the flow disrupter is adjustable in the sense that fingers 71 move angularly with respect to the distance that nipple 57 projects against fingers 71. The amount of turbulence induced by the flow disrupter may be varied by advancing coupler external thread 64 relative to coupler internal thread 62. As coupler external thread 64 is advanced or is backed off along coupler internal thread 62, nipple 57 is advanced or is retracted against fingers 71. The further coupler external thread 64 is backed off along coupler internal thread 62, the further nipple 57 is withdrawn against fingers 71 and the further fingers 71 project into pressurized flow P, the higher the turbulence, the higher the rate of foam generation and the shorter projection of pressurized flow P from variable aeration mixing rate nozzle 50. Conversely, the further coupler external thread 64 advances along coupler internal thread 62, the further nipple 57 advances against fingers 71 and the further fingers 71 are radially disposed relative to pressurized flow P, the lower the turbulence, the lower the rate of foam generation and the longer projection of pressurized flow P from variable aeration mixing rate nozzle 50.

In one preferred embodiment of the invention, and referring to FIG. 1, optimum performance has been observed wherein pump 12 is configured as an 10-30 gpm inline pump powered by a 3 to 15 hp gasoline engine 11 supplying a medium pressure, 50-150 p.s.i, pressurized flow P. Employing this pump/engine configuration, and referring to FIG. 3, a variable aeration mixing rate nozzle 25 includes first nozzle segment 27 having an inlet diameter D1 substantially equal to 0.750 inches and a venturi neck diameter D2 substantially equal to 0.200 inches. Threaded aperture 34 is located upstream from venturi 32 a distance substantially equal to 0.440 inches. Second nozzle segment 28 includes a nominal bore diameter D3 substantially equal to 0.500 inches with flare 40 including a 1.5° flare angle resulting in a discharge diameter D4 substantially equal to 0.725 inches.

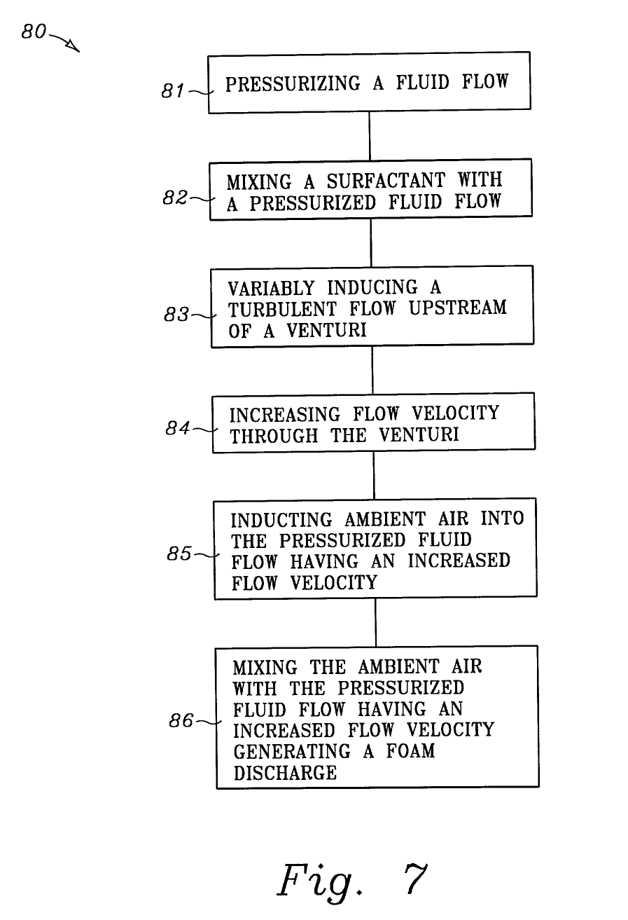

FIG. 7 is a schematic flow chart diagram of a method for generating a foam discharge at a variable aeration mixing rate nozzle. A method for generating a foam discharge at a variable aeration mixing rate nozzle 80 includes the steps of PRESSURIZING A FLUID FLOW 81, MIXING A SURFACTANT WITH A PRESSURIZED FLUID FLOW 82, VARIABLY INDUCING A TURBULENT FLOW UPSTREAM OF A VENTURI 83, INCREASING FLOW VELOCITY THROUGH THE VENTURI 84, INDUCTING AMBIENT AIR INTO THE PRESSURIZED FLUID FLOW HAVING AN INCREASED FLOW VELOCITY 85, and MIXING THE AMBIENT AIR WITH THE PRESSURIZED FLUID FLOW HAVING AN INCREASED FLOW VELOCITY GENERATING A FOAM DISCHARGE 86.

While this invention has been described with reference to the detailed embodiments, this is not meant to be construed in a limiting sense. Those skilled in the art will appreciate the fact that various modifications to the described embodiments, as well as additional embodiments of the invention, will be apparent upon reference to this description. It is therefore contemplated that the appended claims will cover any such modifications or embodiments as fall within the true scope of the invention.

I claim:

1. A fire suppression apparatus comprising:
a motor;
a pump connected to and driven by the motor providing a pressurized fluid flow, the pump including an intake line fluidly connected to a water source, the pump also including a pump discharge;
a mixing chamber fluidly connected to the pump discharge;
a surfactant reservoir hydraulically connected to the mixing chamber via a conduit;
a discharge line connected to the mixing chamber; and
a variable aeration mixing nozzle connected to the discharge line.

2. The fire suppression apparatus of claim 1 further comprising a surfactant contained in the surfactant reservoir.

3. The fire suppression apparatus of claim 1 wherein the variable aeration mixing nozzle further comprises:
a nozzle section including an aperture extending along a longitudinal axis of the nozzle section, the nozzle section connected to the discharge line;
a venturi formed in the nozzle section aperture;
an adjustable stream flow disrupter connected to the nozzle section and projecting into the pressurized fluid flow and the aperture;
one or more air intake apertures formed downstream from the venturi and through a wall of the nozzle section at an angle to the longitudinal axis of the nozzle section.

4. The variable aeration mixing nozzle of claim 3 wherein the nozzle section further comprises:
a first nozzle segment; and
a second nozzle segment threadedly connected to the first nozzle segment.

5. The variable aeration mixing nozzle of claim 3 wherein the nozzle section further comprises a threaded end for connection to the discharge line.

6. The variable aeration mixing nozzle of claim 3 wherein the adjustable stream flow disrupter further comprises a screw threadedly and adjustably extending through a wall of the nozzle section into the aperture extending along the longitudinal axis of the nozzle section inducing a turbulent flow in the pressurized fluid flow through the aperture.

7. The variable aeration mixing nozzle of claim 3 wherein the adjustable stream flow disrupter further comprises a screw threadedly and adjustably extending through a wall of the nozzle section upstream of the venturi and into the aperture extending along the longitudinal axis of the nozzle section inducing a turbulent flow in the pressurized fluid flow through the aperture.

8. A variable aeration mixing nozzle comprising:
a nozzle section including an aperture extending along a longitudinal axis of the nozzle section, the nozzle section connectable to a discharge line;
a venturi formed in the nozzle section aperture;
an adjustable stream flow disrupter connected to the nozzle section, the adjustable stream flow disrupter extending into the pressurized fluid flow through the aperture extending along the longitudinal axis of the nozzle section;
one or more air intake apertures formed through a wall of the nozzle section at an angle to the longitudinal axis of the nozzle section and downstream from the venturi.

9. The variable aeration mixing nozzle of claim 8 wherein the nozzle section further comprises:
a first nozzle segment; and
a second nozzle segment threadedly connected to the first nozzle segment.

10. The variable aeration mixing nozzle of claim 8 wherein the nozzle section further comprises a threaded end for connection to a discharge line.

11. The variable aeration mixing nozzle of claim 8 wherein the adjustable stream flow disrupter further comprises a screw threadedly and adjustably extending through a wall of the nozzle section into the aperture extending along the longitudinal axis of the nozzle section inducing a turbulent flow in a pressurized fluid flow through the aperture.

12. The variable aeration mixing nozzle of claim 8 wherein the adjustable stream flow disrupter further comprises a screw threadedly and adjustably extending through a wall of the nozzle section upstream of the venturi and into the aperture extending along the longitudinal axis of the nozzle section inducing a turbulent flow in the pressurized fluid flow through the aperture.

13. A variable aeration mixing nozzle comprising:
a first nozzle segment including an aperture extending along a longitudinal axis of the first nozzle segment, the first nozzle segment connectable to a discharge line;
a nipple formed contiguous to, concentric with and extending from a downstream end of the first nozzle segment, the nipple including an aperture extending along a longitudinal axis of the nipple;
a second nozzle segment including an aperture extending along a longitudinal axis of the second nozzle segment, the second nozzle segment threadedly connectable to the first nozzle segment, the nipple of the first second nozzle segment insertable within the second nozzle segment aperture;
a venturi formed in the first nozzle segment;
a finger assembly including one or more fingers attached to a finger retainer, each of the one or more fingers extending at an adjustable finger angle from the finger retainer, the finger assembly disposed between the first nozzle segment and the second nozzle segment, the nipple of the first nozzle segment insertable against the one or more fingers for radially disposing the one or more fingers within the second nozzle segment aperture for providing a variable aeration mixing rate; and
one or more air intake apertures formed through a wall of the second nozzle segment at an angle to the longitudinal axis of the nozzle section and downstream from the venturi.

14. The variable aeration mixing nozzle of claim 13 further comprising a venturi formed in the second nozzle segment.

15. The variable aeration mixing nozzle of claim 13 wherein the first nozzle segment further comprises a threaded end for connection to a discharge line.

16. The variable aeration mixing nozzle of claim 13 wherein the finger assembly further comprises finger assembly including one or more fingers attached to a finger retainer, each of the one or more fingers extending at an adjustable finger angle from the finger retainer, the finger assembly disposed between the first nozzle segment and the second nozzle segment, the nipple of the first nozzle segment insertable against the one or more fingers for radially disposing the one or more fingers within the second nozzle segment aperture for inducing a turbulent flow in the pressurized fluid flow through the aperture and providing a variable aeration mixing rate.

17. A method for generating a foam discharge at a variable aeration mixing rate nozzle including the steps of:
pressurizing a fluid flow;
mixing a surfactant with the pressurized fluid flow;
variably inducing a turbulent flow upstream of a venturi providing a variable aeration mixing rate;
increasing flow velocity through the venturi;
inducting ambient air into the pressurized fluid flow having an increased flow velocity; and
mixing the ambient air with the pressurized fluid flow having an increased flow velocity generating a foam discharge.
